(19) United States
(12) Patent Application Publication
(10) Pub. No.: US 2012/0081618 A1
(43) Pub. Date: Apr. 5, 2012

(54) LIGHT EMITTING MODULE, ILLUMINATING DEVICE, DISPLAY DEVICE, AND TELEVISION RECEIVING DEVICE

(75) Inventor: Keitaro Matsui, Osaka-shi (JP)

(73) Assignee: SHARP KABUSHIKI KAISHA, Osaka-shi, Osaka (JP)

(21) Appl. No.: 13/376,386

(22) PCT Filed: Mar. 15, 2010
(86) PCT No.: PCT/JP2010/054304

§ 371 Date: Dec. 6, 2011

(30) Foreign Application Priority Data
Jun. 15, 2009 (JP) 2009-141901

(51) Int. Cl. F21V 5/04; H04N 3/14; G02F 1/13357

(52) U.S. Cl. 348/790; 362/311.01; 349/62; 348/E03.016

(57) ABSTRACT

Leg portions (12) are formed so as to project from a back surface (11B) of a lens (11). Further, distal ends (12t) of the leg portions (12) come into close contact with a mounting surface (21U) of a mounting substrate (21) so that the lens (11) is mounted on the mounting substrate (21).

### TECHNICAL FIELD

The present invention relates to alight emitting module including a light source such as a light emitting element, an illuminating device that employs the light emitting module, a display device having the illuminating device mounted thereon, and a television receiving device having the display device mounted thereon.

### BACKGROUND ART

In a liquid crystal display device (display device) having a non-light emitting liquid crystal display panel (display panel) mounted thereon, in general, a backlight unit (illuminating device) for supplying light to the liquid crystal display panel is also mounted. There are various types of light sources for the backlight unit. For example, in a case of the backlight unit disclosed in Patent Literature 1, the light source is a light emitting diode (LED).

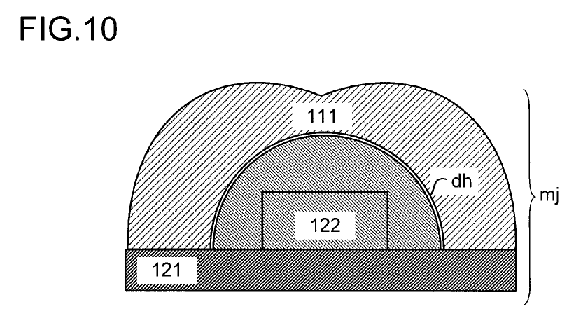

In the backlight unit, as illustrated in FIG. 10, an LED (light emitting element) 122 mounted on a mounting substrate 121 is covered with a lens 111 having a recess dh capable of housing the LED 122 (note that, a module including the LED 122, the lens 111, and the mounting substrate 121 is referred to as “light emitting module mj”). Further, light from the LED 122 travels in a desired direction while being diffused via the lens 111.

### CITATION LIST

### Patent Literature

Patent Literature 1: JP 2006-92983 A

### SUMMARY OF INVENTION

### Technical Problem

By the way, in general, the LED 122 generates heat along with light emission. Further, when the temperature of the heat is excessively high, light emission luminance of the LED 122 decreases due to the excessively high temperature. In the case of the LED module mj as illustrated in FIG. 10, the heat of the LED 122 is trapped in a narrow space surrounded by the mounting substrate 121 and the housing recess dh of the lens 111.

In this structure, the heat is not easily dissipated, and as a result, the light emission luminance of the LED 122 decreases due to the heat of the LED 122 itself. Therefore, in the LED module mj having the LED 122 mounted thereon, it is difficult to ensure desired luminance.

The present invention has been made to solve the above-mentioned problem. Further, it is therefore an object of the present invention to provide a light emitting module and the like capable of ensuring luminance of a light emitting element at a constant level or higher by efficiently dissipating heat generated in the light emitting element.

### Solution to Problem

A light emitting module includes a light emitting element, a mounting substrate having a mounting surface on which the light emitting element is mounted, and a lens having a lens surface for allowing light from the light emitting element to exit therethrough. Further, in the light emitting module, the lens has a back surface on which leg portions are formed so as to project from the back surface, and distal ends of the leg portions come into close contact with the mounting surface so that the lens is mounted on the mounting substrate.

With this structure, a clearance is created between the mounting substrate and the lens . In this case, even when the light emitting element generates heat due to the light emission, the heat is cooled through the clearance. Therefore, the temperature of the light emitting element does not become high due to the heat generated by the light emitting element itself, and thus the luminance does not decrease due to the high temperature. As a result, the light emitting module capable of ensuring the luminance of the light emitting element at a constant level or higher is attained.

Further, it is desired that the leg portions be at least three leg portions. With this structure, the lens is supported at three points on the mounting substrate via the leg portions so that the lens is not easily inclined from a desired position. Therefore, there is no occurrence of such a situation that transmitted light from the lens does not travel in a desired direction due to the inclination of the lens.

Further, it is desired that the mounting surface include holes formed therein, the holes housing at least the distal ends of the leg portions. With this structure, the leg portions of the lens are engaged with the holes of the mounting surface, and thus the lens is fixed in an in-plane direction of the mounting surface. Therefore, there is no occurrence of such a situation that the transmitted light from the lens does not travel in a desired direction due to the shift of the desired position of the lens relative to the light emitting element.

Further, it is even more desired that the lens and the mounting substrate be bonded to each other by applying an adhesive to an inner side of the holes. With this structure, the lens is mounted on the mounting substrate more stably. Besides, the adhesive is embedded into the holes, and thus the adhesive does not adhere to the back surface of the lens. In this case, the light traveling around the inner side of the lens is not easily absorbed by the adhesive. Thus, it is possible to suppress the loss of the transmitted light from the lens.

Further, an illuminating device including the above-mentioned light emitting module may also be regarded as the present invention, and further, a display device including the illuminating device and a display panel that receives light from the illuminating device may also be regarded as the present invention.

### ADVANTAGEOUS EFFECTS OF INVENTION

According to the present invention, the light emitting element is easily exposed to outside air, and hence the heat generated in the light emitting element is easily dissipated. Therefore, the luminance of the light emitting element does not easily decrease due to the heat of the light emitting element itself. As a result, the light emitting module can ensure desired luminance at a constant level or higher.

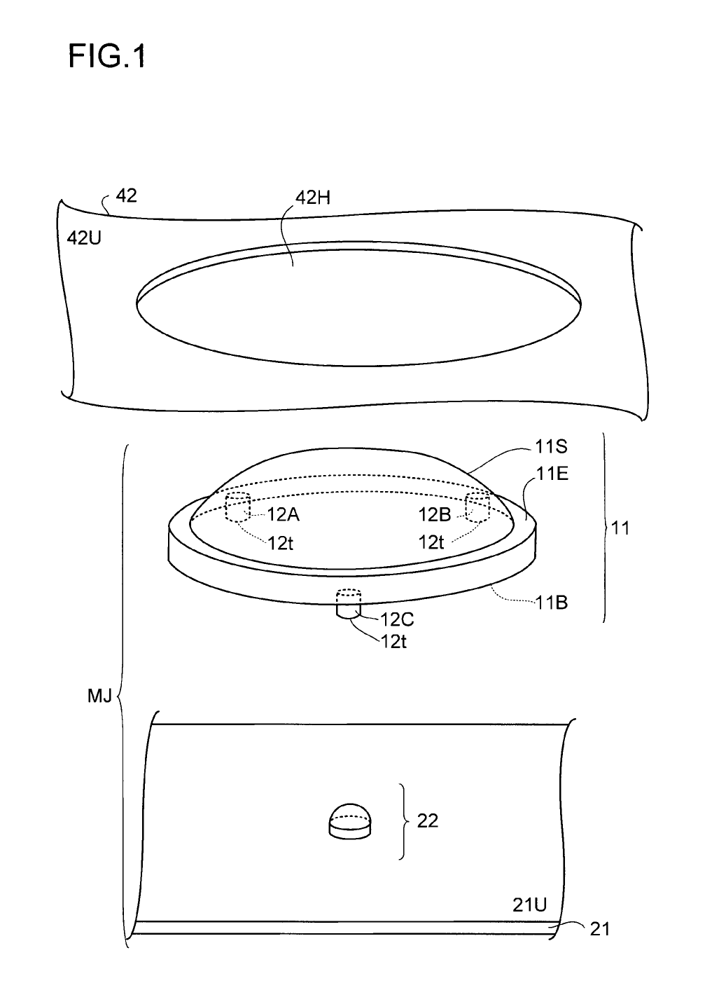

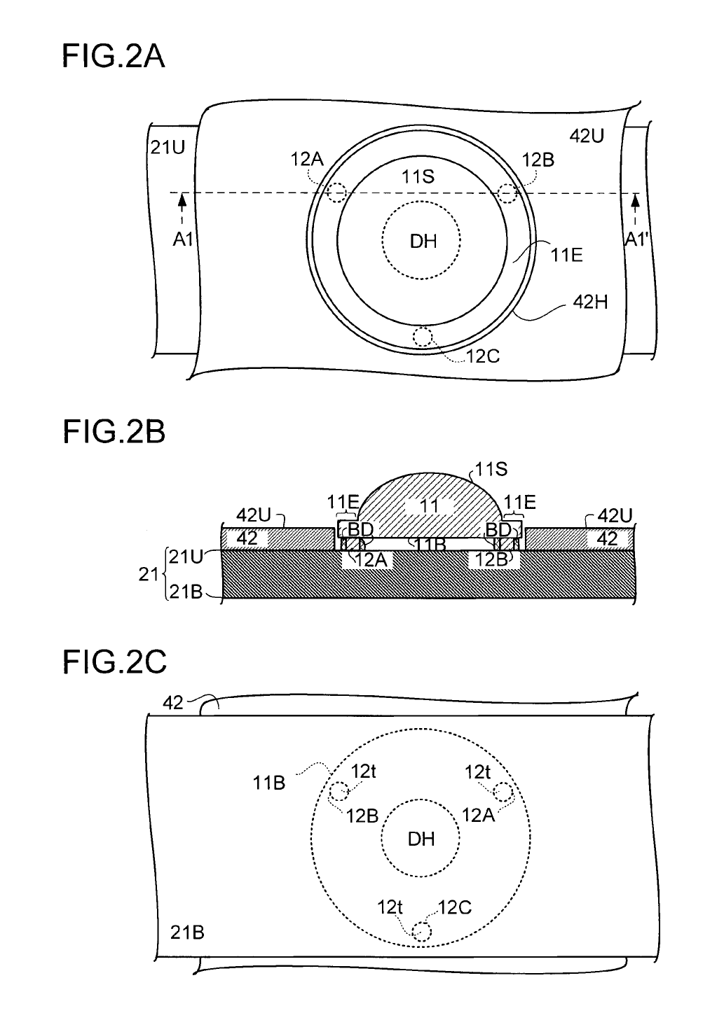

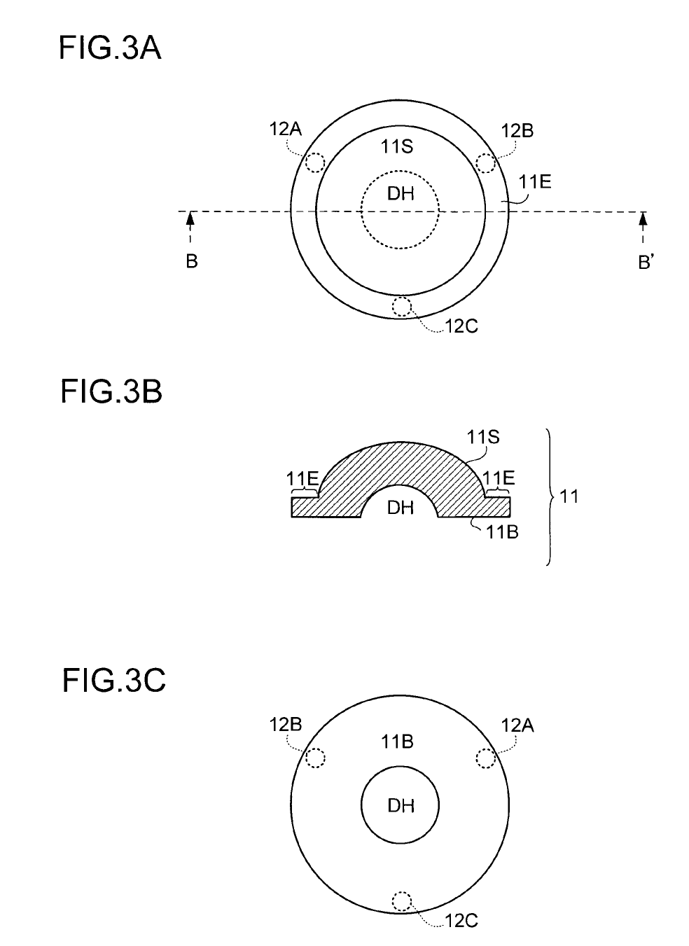

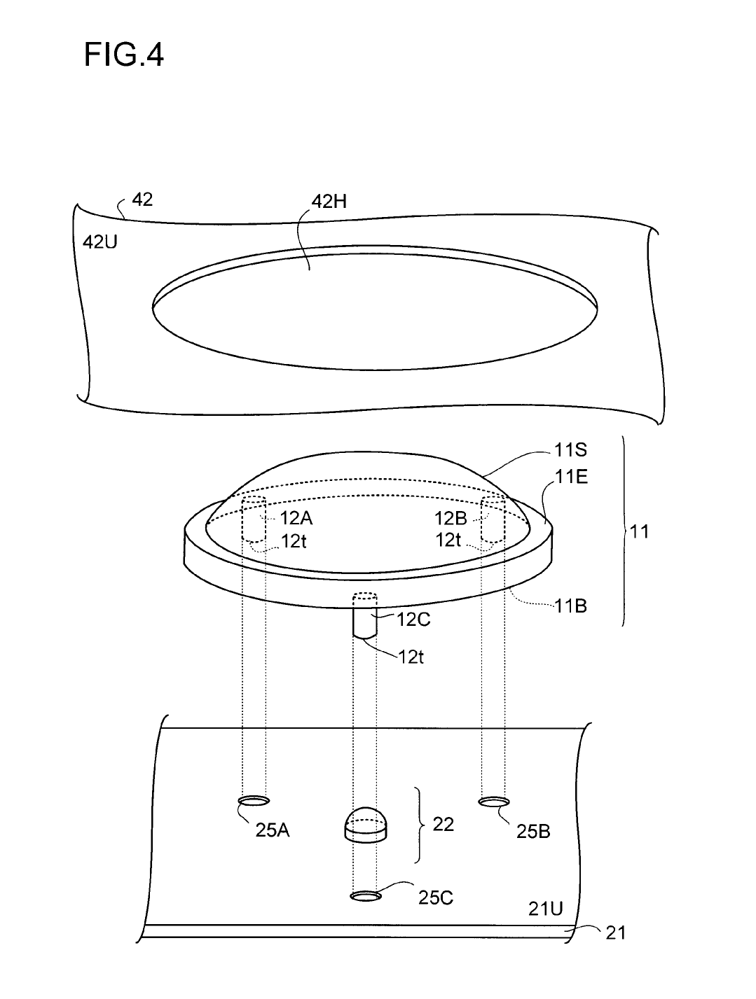

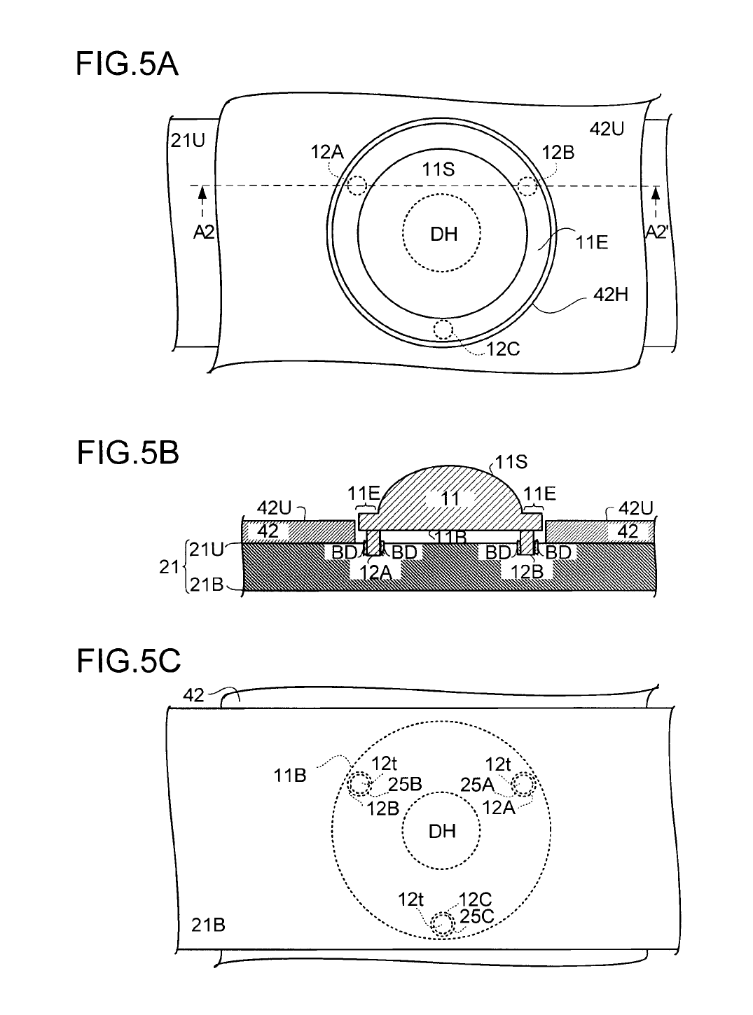

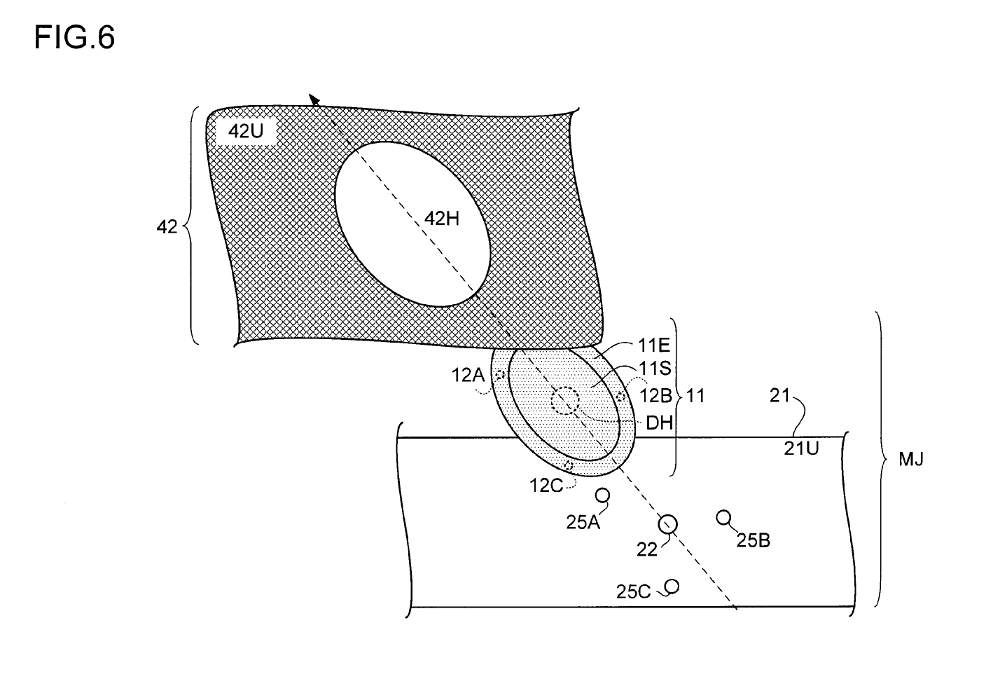

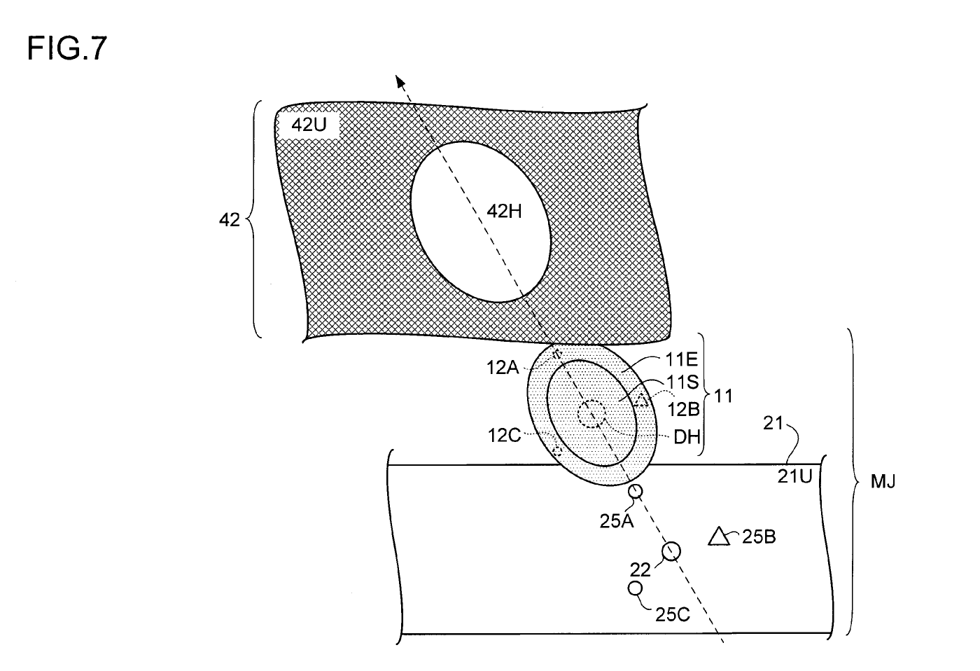

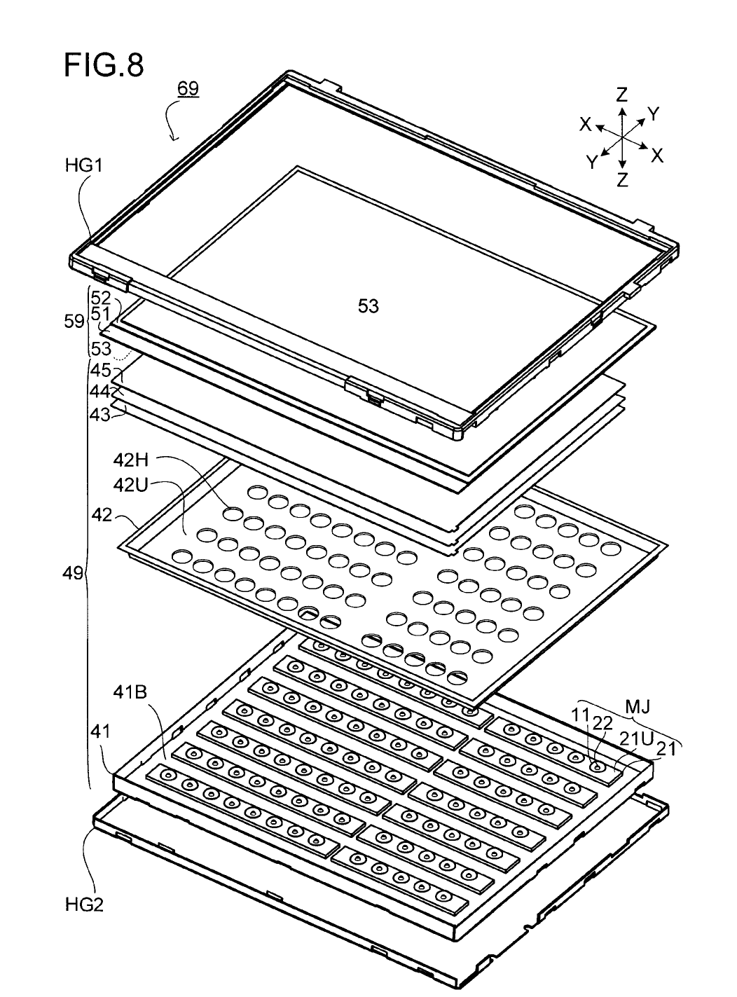

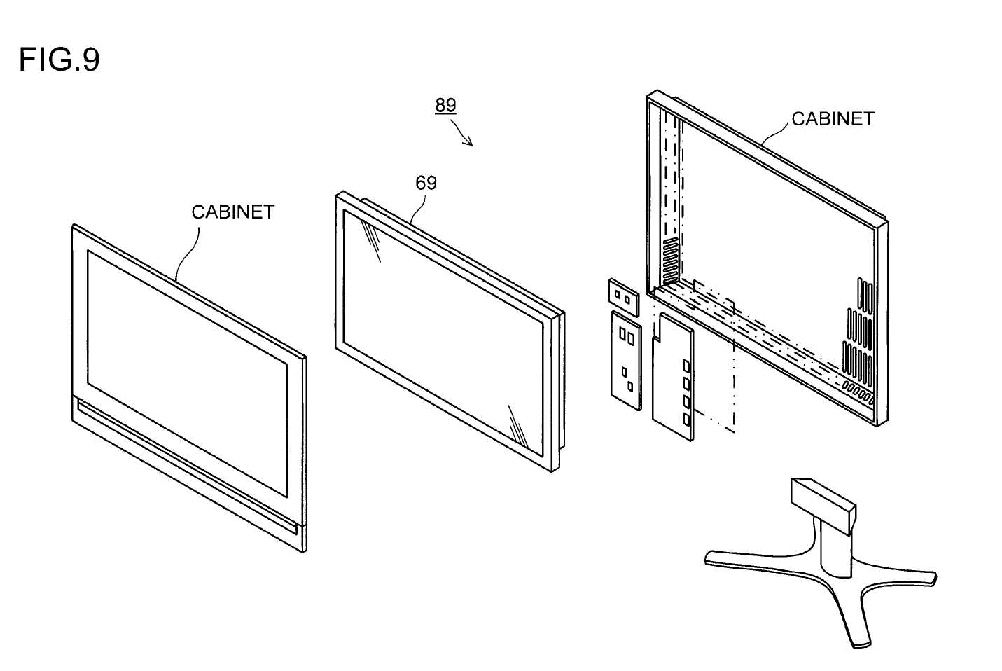

### BRIEF DESCRIPTION OF DRAWINGS

[FIG. 1] An exploded perspective view of an LED module.

[FIG. 2A] A plan view of a front surface side of the LED module.

[FIG. 2B] A sectional view of the LED module taken along the arrow A1-A1′ of FIG. 2A.

[FIG. 2C] A plan view of a back surface side of the LED module.

[FIG. 3A] A plan view of a front surface side of a lens.

[FIG. 3B] A sectional view of the lens taken along the arrow B-B′ of FIG. 3A.

[FIG. 3C] A plan view of a back surface side of the lens.

[FIG. 4] An exploded perspective view of an LED module.

[FIG. 5A] A plan view of a front surface side of the LED module.

[FIG. 5B] A sectional view of the LED module taken along the arrow A2-A2′ of FIG. 5A.

[FIG. 5C] A plan view of a back surface side of the LED module.

[FIG. 6] An exploded plan view of the LED module.

[FIG. 7] An exploded plan view of the LED module.

[FIG. 8] An exploded perspective view of a liquid crystal display device.

[FIG. 9] An exploded perspective view of a liquid crystal television set having the liquid crystal display device mounted thereon.

[FIG. 10] A sectional view illustrating a conventional LED module.

### DESCRIPTION OF EMBODIMENTS

### First Embodiment

An embodiment of the present invention is described below with reference to the drawings. Note that, hatching, reference symbols of members, or the like may be omitted for convenience, and in such a case, reference is supposed to be made to other drawings. Conversely, hatching may be placed for convenience even in other views than sectional views.

FIG. 9 illustrates a liquid crystal television set 89 having a liquid crystal display device (display device) 69 mounted thereon. Note that, such a liquid crystal television set 89 receives television broadcast signals to display images, and therefore may be referred to as “television receiving device”. FIG. 8 is an exploded perspective view illustrating the liquid crystal display device (display device) 69. As illustrated in the figure, the liquid crystal display device 69 includes a liquid crystal display panel (display panel) 59, a backlight unit (illuminating device) 49 for supplying light to the liquid crystal display panel 59, and housings HG (front housing HG1 and rear housing HG2) sandwiching the liquid crystal display panel 59 and the backlight unit 49.

The liquid crystal display panel 59 is obtained by bonding an active matrix substrate 51 including switching elements such as thin film transistors (TFTs) and a counter substrate 52 opposed to the active matrix substrate 51 to each other with a sealing material (not shown). Further, liquid crystal (not shown) is injected into a clearance between both the substrates 51 and 52.

Note that, polarizing films 53 are respectively disposed on a light receiving surface side of the active matrix substrate 51 and a light exiting side of the counter substrate 52. Further, the liquid crystal display panel 59 as described above utilizes a change in transmittance due to the tilt of liquid crystal molecules to display images.

Next, description is given of the backlight unit 49 that is positioned immediately below the liquid crystal display panel 59. The backlight unit 49 includes LED modules (light emitting modules) MJ, a backlight chassis 41, a large-sized reflection sheet 42, a diffusion plate 43, a prism sheet 44, and a microlens sheet 45.

The LED module MJ is illustrated in FIG. 8, and also illustrated in FIG. 1 as an exploded perspective view, FIG. 2A as a plan view of a front surface side, FIG. 2B as a sectional view taken along the arrow A1-A1′ of FIG. 2A, and FIG. 2C as a plan view of a back surface side (note that, in the figures except for FIG. 2B, an adhesive BD described later is omitted for convenience). As illustrated in those figures, the LED module MJ includes amounting substrate 21, a light emitting diode (LED) 22, and a lens 11.

The mounting substrate 21 is a plate-like, rectangular substrate, and has a mounting surface 21U on which a plurality of electrodes (not shown) are arranged. Further, the LEDs 22 that are light emitting elements are mounted on the electrodes. Note that, on the mounting surface 21U of the mounting substrate 21, a resist film (not shown) serving as a protective film is formed. The resist film is not particularly limited, and the resist film is desired to be white with reflectivity. This is because, even when light enters the resist film, the light is reflected on the resist film to travel toward the outside, which eliminates the cause of unevenness in light quantity corresponding to absorption of light by the mounting substrate 21.

The LED 22 is alight source, and emits light by a current flowing via the electrode of the mounting substrate 21. Further, there are many types of LEDs 22, and the following types of LEDs 22 are taken as examples thereof. For example, the LED 22 includes an LED chip (light emitting chip) for emitting blue light, and a phosphor for emitting yellow fluorescent light when receiving light from the LED chip (note that, the number of LED chips is not particularly limited). Such an LED 22 generates white light by the light from the LED chip for emitting blue light and the emitted fluorescent light.

Note that, the phosphor included in the LED 22 is not limited to the phosphor for emitting yellow fluorescent light. For example, the LED 22 may include an LED chip for emitting blue light, and phosphors for emitting green fluorescent light and red fluorescent light when receiving light from the LED chip, to thereby generate white light by the blue light from the LED chip and the emitted fluorescent light (green light and red light).

Further, the LED chip included in the LED 22 is not limited to the LED chip for emitting blue light. For example, the LED 22 may include a red LED chip for emitting red light, a blue LED chip for emitting blue light, and a phosphor for emitting green fluorescent light when receiving light from the blue LED chip. This is because such an LED 22 can generate white light by the red light from the red LED chip, the blue light from the blue LED chip, and the emitted green fluorescent light.

Further, the LED 22 may be devoid of the phosphor. For example, the LED 22 may include a red LED chip for emitting red light, a green LED chip for emitting green light, and a blue LED chip for emitting blue light, to thereby generate white light by the light from every LED chip.

Further, on the backlight unit 49 illustrated in FIG. 8, there are mounted relatively-short mounting substrates 21 on each of which five LEDs 22 are mounted in line, and relatively-long mounting substrates 21 on each of which eight LEDs 22 are mounted in line.

In particular, the two types of mounting substrates 21 are arranged so that the array of the five LEDs 22 and the array of the eight LEDs 22 are combined into an array of thirteen LEDs 22, and further, the two types of mounting substrates 21 are arranged in a direction intersecting with (for example, orthogonal to) the direction in which the thirteen LEDs 22 are arranged. Accordingly, the LEDs 22 are arranged in matrix to emit planar light (for convenience, the direction in which the different types of mounting substrates 21 are arranged is referred to as “X direction”, the direction in which the same type of mounting substrates 21 are arranged is referred to as “Y direction”, and the direction intersecting with the X direction and the Y direction is referred to as “Z direction”).

Note that, the thirteen LEDs 22 arranged in the X direction are electrically connected in series, and further, the thirteen LEDs 22 thus connected in series are electrically connected in parallel to other thirteen LEDs 22 connected in series, which are adjacent to the above-mentioned thirteen LEDs 22 along the Y direction. Further, the LEDs 22 arranged in matrix are driven in parallel.

The lens 11 receives light from the LED 22, and allows the light to pass therethrough (to exit). Specifically, as illustrated in a plan view of a front surface side that is illustrated in FIG. 3A, a sectional view taken along the arrow B-B′ of FIG. 3A that is illustrated in FIG. 3B, and a plan view of a back surface side that is illustrated in FIG. 3C, the lens 11 includes a housing recess DH capable of housing the LED 22 on a back surface 11B side of the lens 11 having a light-transmitting surface 11S (note that, it is desired that the housing recess DH be positioned in the vicinity of the center of the lens surface 11S and the back surface 11B of the lens).

Further, the positions of the housing recess DH and the LED 22 are aligned, and the lens 11 covers the LED 22 on the mounting substrate 21. In this case, the LED 22 is embedded into the lens 11, and accordingly the light from the LED 22 is reliably supplied into the lens 11. Further, most of the supplied light exits toward the outside via the lens surface 11S.

Note that, the lens 11 includes, on an outer edge 11E thereof, columnar leg portions 12 (12A to 12C) projecting so as to separate from the back surface 11B of the lens. Further, distal ends 12t of the leg portions 12 come into contact with the mounting surface 21U of the mounting substrate 21, and by applying the adhesive BD (see FIG. 2B) to the contact part, the lens 11 and the mounting substrate 21 are bonded to each other.

Further, the material for the lens 11 is not particularly limited as long as the light is allowed to pass therethrough. For example, as the material for the lens 11, an acrylic resin may be employed (an acrylic resin having a refractive index nd of from 1.49 to 1.50 may be employed).

As illustrated in FIG. 8, the backlight chassis 41 is, for example, a box-like member, and has a bottom surface 41B on which the LED modules MJ are closely arranged, to thereby house the plurality of LED modules MJ. Note that, the bottom surface 41B of the backlight chassis 41 and the mounting substrate 21 of the LED module MJ are connected to each other via rivets (not shown).

Further, to the bottom surface 41B of the backlight chassis 41, there may be provided support pins for supporting the diffusion plate 43, the prism sheet 44, and the microlens sheet 45 (note that, the backlight chassis 41 may support the diffusion plate 43, the prism sheet 44, and the microlens sheet 45, which are stacked in the stated order, with top portions of side walls thereof together with the support pins).

The large-sized reflection sheet 42 is an optical sheet having a reflection surface 42U, and covers the plurality of LED modules MJ arranged in matrix with a rear surface of the reflection surface 42U facing the LED modules MJ. Note that, the large-sized reflection sheet 42 includes through-holes 42H aligned with the positions of the lenses 11 of the LED modules MJ, to thereby expose the lenses 11 through the reflection surface 42U (note that, the large-sized reflection sheet 42 is preferred to include holes for exposing the above-mentioned rivets and support pins therethrough).

In this case, even when part of the light exiting from the lenses 11 travels toward the bottom surface 41B of the backlight chassis 41, the light is reflected on the reflection surface 42U of the large-sized reflection sheet 42, and travels so as to separate from the bottom surface 41B. Thus, with the large-sized reflection sheet 42, the light of the LEDs 22 is not lost and travels toward the diffusion plate 43 opposed to the reflection surface 42U.

The diffusion plate 43 is an optical sheet stacked on the large-sized reflection sheet 42, and diffuses the light emitted from the LED modules MJ and the light reflected from the large-sized reflection sheet 42. In other words, the diffusion plate 43 diffuses the planar light formed by the plurality of LED modules MJ to spread the light over the entire region of the liquid crystal display panel 59.

The prism sheet 44 is an optical sheet stacked on the diffusion plate 43. Further, on the prism sheet 44, for example, triangular prisms extending in one direction (in a linear manner) are arranged in a direction intersecting with the one direction in a plane of the sheet. Accordingly, the prism sheet 44 deviates a radiation characteristic of the light from the diffusion plate 43. Note that, the prisms are preferred to extend along the Y direction, in which fewer LEDs 22 are arranged, and to be arranged along the X direction, in which more LEDs 22 are arranged.

The microlens sheet 45 is an optical sheet stacked on the prism sheet 44. Further, inside the microlens sheet 45, fine particles for refracting and scattering the light are dispersed. Accordingly, the microlens sheet 45 reduces a difference in brightness (unevenness in light quantity) without locally condensing the light from the prism sheet 44.

Further, the backlight unit 49 as described above allows the planar light formed by the plurality of LED modules MJ to pass through the plurality of optical sheets 43 to 45, to thereby supply the light to the liquid crystal display panel 59. Accordingly, the non-light emitting liquid crystal display panel 59 receives the light from the backlight unit 49 (backlight) to improve a display function thereof.

Now, detailed description is given of the leg portions 12 of the lens 11. The leg portions 12 are formed so as to project from the back surface 11B of the lens 11. Further, the distal ends 12t of the leg portions 12 come into close contact with the mounting surface 21U of the mounting substrate 21 so that the lens 11 is mounted on the mounting substrate 21.

With this structure, a clearance is created between the mounting surface 21U and the lens 11 (specifically, a clearance is created between the back surface 11B of the lens 11 and the mounting surface 21U of the mounting substrate 21). In this case, even when the LED 22 generates heat due to the light emission, the heat is cooled through the clearance.

Specifically, outside air enters the housing recess DH that houses the LED 22 through the clearance, and accordingly the heat generated in the LED 22 easily escapes (that is, when the clearance is created between the back surface 11B of the lens 11 and the mounting surface 21U by the leg portions 12 of the lens 11, drive heat of the LED 22 easily escapes to the outside without staying in a narrow space that is the housing recess DH of the lens 11).

As a result, junction temperature of the LED 22 does not become high, and hence the LED 22 emits light without decreasing luminance. Further, in a case where the LED 22 is cooled in this manner, the LED 22 is preferred to be a power LED (LED capable of ensuring an illuminance of at least several tens to hundreds of lumens by a relatively large electric power of several watts).

This is because the power LED is likely to generate heat due to its relatively larger power consumption as compared to general LEDs. It can therefore be said that, when the LED 22 is a power LED in the LED module MJ in which heat generation of the LED 22 is suppressed, heat dissipation utilizing the clearance between the lens 11 and the mounting substrate 21 is extremely effective.

Besides, when a power LED is mounted in such an LED module MJ, the light emission luminance of each LED 22 is relatively high, and hence the number of LEDs 22 can be reduced relatively. Thus, cost of the LED module MJ can be reduced.

Note that, in the above description, the number of leg portions 12 of the lens 11 is three, but at least two leg portions 12 may suffice. This is because, for example, when two leg portions 12 are arranged to be rotationally symmetric (for example, point symmetric) about the housing recess DH, the lens 11 can stand on the mounting surface 21U using the leg portions 12.

However, in the case where the number of leg portions 12 is two, the lens 11 can stand on the mounting surface 21U using the leg portions 12, but is easily inclined (that is, the mounting surface 21U and the back surface 11B of the lens 11 is not easily maintained in parallel to each other). Further, when the lens 11 is inclined from a desired position (for example, position parallel to the mounting surface 21U), the light passing through the lens 11 (transmitted light) does not travel in a desired direction. Then, there is a risk that the planar light emitted from the LED module MJ contains the unevenness in light quantity.

Therefore, it is desired that the number of leg portions 12 of the lens 11 be three or more. With this structure, the lens 11 is supported at three points so that the lens 11 is not inclined (note that, the lengths of the three leg portions 12 are designed appropriately so that, for example, the back surface 11B of the lens 11 faces the mounting surface 21U in parallel). Further, as long as the lens 11 is not inclined (that is, the lens surface 11S is arranged as designed) as described above, the planar light emitted from the LED module MJ does not contain any unevenness in light quantity.

### Second Embodiment

A second embodiment of the present invention is described. Note that, members having functions similar to those of the members used in the first embodiment are represented by the same reference symbols, and description thereof is therefore omitted herein.

In the LED module MJ of the first embodiment, the leg portions 12 of the lens 11 and the flat mounting surface 21U are bonded to each other with the adhesive BD (see FIG. 2B). There are many types of such adhesives, and there is also an adhesive having an optical absorption property. Therefore, there is an LED module MJ suitable for the case of using such an adhesive having an optical absorption property.

Such an LED module MJ is illustrated in FIG. 4 and FIGS. 5A to 5C. FIG. 4 is an exploded perspective view of the LED module MJ. FIG. 5A is a plan view of a front surface side, FIG. 5B is a sectional view taken along the arrow A2-A2′ of FIG. 5A, and FIG. 5C is a plan view of a back surface side (note that, in the figures except for FIG. 5B, the adhesive BD is omitted for convenience).

As illustrated in those figures, the LED module MJ of the second embodiment is different from the LED module MJ of the first embodiment (see FIG. 1 and FIGS. 2A to 2C) in that holes 25 (25A to 25C) for fitting the leg portions 12 therein are formed in the mounting substrate 21.

The holes 25 each have an inner periphery slightly wider than the periphery of the column of the leg portion 12, and have a depth smaller than the length of the leg portion 12 (note that, the depth may have a length in which the holes 25 can penetrate the mounting substrate 21 or a length in which the holes 25 cannot penetrate the mounting substrate 21). In this case, the holes 25 designed in correspondence with the arrangement of the leg portions 12 can house at least the distal ends 12t of the leg portions 12.

Further, when the adhesive BD adheres to an inner side of the holes 25, the leg portions 12 and the mounting substrate 21 are bonded to each other. Further, in the case of bonding as described above, even when the adhesive BD has an optical absorption property, the light of the LED 22 is not easily absorbed. This is because the adhesive BD adheres to the inner side of the holes 25 but does not adhere to the back surface 11B of the lens 11, with the result that the light traveling toward the back surface 11B of the lens 11 is not easily absorbed by the adhesive BD.

Further, when the leg portions 12 are fitted into the holes 25 as described above, the lens 11 is not easily displaced in an in-plane direction of the mounting surface 21U. Therefore, the position of the lens 11 relative to the LED 22 is fixed, and accordingly the transmitted light from the lens 11 becomes the light as designed. As a result, the LED module MJ generates planar light containing no unevenness in light quantity.

By the way, in the case where such holes 25 are formed in the mounting substrate 21, the arrangement of the holes 25 is reasonably identical with the arrangement of the leg portions 12, and it is preferred that each arrangement be rotationally asymmetric. To represent in the figure, as illustrated in an exploded plan view of FIG. 6, in a case where the three leg portions 12A to 12C are arranged to be rotationally asymmetric, the three holes 25A to 25C are also arranged to be rotationally asymmetric (note that, in FIG. 6, further, the member positioned at the distal end of the broken-line arrow covers the member on the base end side of the broken-line arrow).

This structure allows only one way to engage the leg portions 12A to 12C with the holes 25A to 25C. In other words, the leg portion 12A is fitted into the hole 25A; the leg portion 12B, the hole 25B; and the leg portion 12C, the hole 25C. In this case, as illustrated in FIG. 6, the lens surface 11S is set to, for example, an elliptical shape in front view, which is effective in a case where a lens 11 for polarizing the transmitted light from the above-mentioned lens surface 11S in a specific direction is mounted on the mounting substrate 21.

This is because, in the case of such a lens 11, the position of each lens 11 on the mounting substrate 21 (orientation of the lens 11) is determined precisely, and positioning of the lens 11 can be easily performed. Specifically, when the holes 25A to 25C are appropriately formed in advance in the mounting substrate 21 in correspondence with the arrangement of the leg portions 12A to 12C of the lens 11, the manufacturer cannot mount the lens 11 at a position other than the predetermined position, and hence the positioning of the lens 11 can be easily performed.

Further, the positioning of the lens 11 can be facilitated even when the leg portions 12 are rotationally symmetric. For example, as illustrated in an exploded perspective view of FIG. 7, it is assumed that the leg portions 12A to 12C are arranged to be rotationally symmetric (arranged in a regular triangle shape) and the holes 25A to 25C are similarly arranged to be rotationally symmetric.

However, when the three leg portions 12A to 12C have different shapes, that is, when the leg portions 12A and 12C have a cylindrical shape and the leg portion 12B has a triangular prism shape (needless to say, the holes 25A and 25C have a cylindrical shape and the hole 25B has a triangular prism shape) as illustrated in, for example, FIG. 7, there is only one way to engage the leg portions 12A to 12C with the holes 25A to 25C. Thus, it can be said that the positioning of the lens 11 can be facilitated even in the case of such an LED module MJ.

### Other Embodiments

Note that, the present invention is not limited to the above-mentioned embodiments, and various modifications may be made thereto without departing from the gist of the present invention.

For example, in the backlight unit 49 having the LED modules MJ mounted thereon, which is illustrated in FIG. 8, a large number of the LEDs 22 are mounted, and further, each LED 22 is covered with the lens 11. Therefore, the drive heat of the LED 22 is likely to stay in the narrow space that is the housing recess DH of the lens 11 (therefore, the LED 22 cannot maintain a relatively high light intensity due to the drive heat of the LED 22 itself).

Therefore, it is desired that the LED modules MJ be mounted on the backlight chassis 41 made of a material having a high heat dissipation property, such as a metal. With this structure, for example, there is no need to provide a separate heat dissipation member between the mounting substrate 21 and the bottom surface 41B of the backlight chassis 41.

Further, in the above description, the LED 22 that is the light emitting element is employed as the light source, but the present invention is not limited thereto. For example, the light emitting element may be made of a self-light emitting material such as an organic electro-luminescence (EL) material and an inorganic EL material.

Further, the adhesive BD is not necessarily used for connection between the lens 11 and the mounting substrate 21. For example, when engagement pieces to be engaged with the edges of the holes 25 are provided at the distal ends of the leg portions 12 and therefore the lens 11 is fixed with respect to the mounting substrate 21, the adhesive BD may be omitted.

### REFERENCE SIGNS LIST

11 lens
11S lens surface
11B back surface of lens
11E outer edge of lens
12 leg portion
12t distal end of leg portion
MJ LED module (light emitting module)
21 mounting substrate
21U mounting surface
22 LED (light emitting element)
25 hole
41 backlight chassis
42 large-sized reflection sheet
43 diffusion plate
44 prism sheet
45 microlens sheet
49 backlight unit (illuminating device)
59 liquid crystal display panel (display panel)
69 liquid crystal display device (display device)
89 liquid crystal television set (television receiving device)

1. A light emitting module, comprising:
a light emitting element;
a mounting substrate having a mounting surface on which the light emitting element is mounted; and
a lens having a lens surface for allowing light from the light emitting element to exit therethrough,
wherein the lens has a back surface on which leg portions are formed so as to project from the back surface, and
wherein distal ends of the leg portions come into close contact with the mounting surface so that the lens is mounted on the mounting substrate.

2. A light emitting module according to claim 1, wherein the leg portions comprise at least three leg portions.

3. A light emitting module according to claim 1, wherein the mounting surface comprises holes formed therein, the holes housing at least the distal ends of the leg portions.

4. A light emitting module according to claim 3, wherein the lens and the mounting substrate are bonded to each other by applying an adhesive to an inner side of the holes.

5. An illuminating device, comprising the light emitting module according to claim 1.

6. A display device, comprising:
the illuminating device according to claim 5; and
a display panel that receives light from the illuminating device.

7. A display device according to claim 6, wherein the display panel comprises a liquid crystal display panel.

8. A television receiving device, which has the display device according to claim 6 mounted thereon.
